(19) United States
(12) Patent Application Publication
(10) Pub. No.: US 2023/0376027 A1
(43) Pub. Date: Nov. 23, 2023

(54) REMOTE OPERATION SYSTEM AND REMOTE OPERATION SUPPORT METHOD

(71) Applicant: Woven Planet Holdings, Inc., Tokyo (JP)

(72) Inventor: Yuki Suehiro, Ichikawa-shi (JP)

(73) Assignee: Woven Planet Holdings, Inc., Tokyo (JP)

(21) Appl. No.: 18/185,672

(22) Filed: Mar. 17, 2023

(30) Foreign Application Priority Data
May 17, 2022 (JP) 2022-080827

(51) Int. Cl. G05D 1/00; B60W 10/20; B60W 40/068; B60W 40/105

(52) U.S. Cl. CPC G05D 1/0011; B60W 10/20; B60W 40/068; B60W 40/105; G05D 2201/0213; B60W 2552/35; B60W 2552/40; B60W 2710/202

(57) ABSTRACT

A remote operation system supports a remote operation of a moving body performed by a remote operator. The remote operation system determines a road surface condition in front of the moving body based on a result of recognition by a recognition sensor mounted on the moving body. The remote operation system calculates a first reaction force control amount based on a first parameter corresponding to an actual turn angle of the moving body. The remote operation system adjusts the first reaction force control amount according to the road surface condition and a speed of the moving body. The remote operation system applies a steering reaction force corresponding to the adjusted first reaction force control amount to a steering wheel operated by the remote operator.

### CROSS-REFERENCE TO RELATED APPLICATION

This application claims priority to Japanese Patent Application No. 2022-080827 filed on May 17, 2022, the entire contents of which are incorporated by reference herein.

### BACKGROUND

### Technical Field

The present disclosure relates to a technique for supporting a remote operation of a moving body performed by a remote operator.

### Background Art

Patent Literature 1 discloses a remote operation system including a moving body and a remote operation device that remotely operates the moving body. The moving body includes a wide-angle camera that captures a forward image. In addition, the moving body extracts an image for gaze at a forward gaze point. The remote operation device displays the image for gaze together with an image for driving captured by the wide-angle camera on a display unit.

### LIST OF RELATED ART

Patent Literature 1: Japanese Laid-Open Patent Application No. JP-2017-021517

### SUMMARY

In a remote operation of a moving body performed by a remote operator, it is conceivable to apply a steering reaction force to a steering wheel on the remote operator side, as in a case of a steer-by-wire vehicle. The steering reaction force makes it possible for the remote operator to obtain a steering feeling according to actual travel of the moving body.

However, when the moving body travels on an uneven road surface, an operation of the steering wheel may be affected by the unevenness of the road surface, which may make it difficult for the remote operator to stably perform a steering operation. When the steering operation performed by the remote operator becomes unstable, the travel of the moving body being a target of the remote operation may also become unstable. On the other hand, when the moving body travels on an off-road at a very low speed, such a need that the remote operator desires to feel a sense of the off-road is conceivable. There is room for improvement in steering reaction force control in remote operation.

An object of the present disclosure is to provide a technique capable of flexibly adjusting a steering reaction force depending on a situation, in a remote operation of a moving body performed by a remote operator.

A first aspect relates to a remote operation system for supporting a remote operation of a moving body performed by a remote operator.

The remote operation system includes one or more processors.

The one or more processors are configured to:
determine a road surface condition in front of the moving body based on a result of recognition by a recognition sensor mounted on the moving body;
calculate a first reaction force control amount based on a first parameter corresponding to an actual turn angle of the moving body;
adjust the first reaction force control amount according to the road surface condition and a speed of the moving body; and
apply a steering reaction force corresponding to the adjusted first reaction force control amount to a steering wheel operated by the remote operator.

A second aspect relates to a remote operation support method for supporting a remote operation of a moving body performed by a remote operator.

The remote operation support method includes:
determining a road surface condition in front of the moving body based on a result of recognition by a recognition sensor mounted on the moving body;
calculating a first reaction force control amount based on a first parameter corresponding to an actual turn angle of the moving body;
adjusting the first reaction force control amount according to the road surface condition and a speed of the moving body; and
applying a steering reaction force corresponding to the adjusted first reaction force control amount to a steering wheel operated by the remote operator.

According to the present disclosure, the steering reaction force is adjusted according to the road surface condition in front of the moving body and the speed of the moving body. That is, the steering reaction force is flexibly adjusted depending on a situation. Therefore, remote operability of the moving body by the remote operator is improved.

### BRIEF DESCRIPTION OF DRAWINGS

FIG. 1 is a schematic diagram showing a configuration example of a remote operation system according to an embodiment of the present disclosure;

FIG. 2 is a block diagram showing a configuration example of a vehicle according to an embodiment of the present disclosure;

FIG. 3 is a block diagram showing an example of a sensor group and driving environment information according to an embodiment of the present disclosure;

FIG. 4 is a block diagram showing a configuration example of a remote operator terminal according to an embodiment of the present disclosure;

FIG. 5 is a block diagram for explaining an overview of steering reaction force control according to an embodiment of the present disclosure;

FIG. 6 is a block diagram showing a comparative example of a reaction force control amount calculation unit;

FIG. 7 is a block diagram showing a configuration example of a reaction force control amount calculation unit according to an embodiment of the present disclosure;

FIG. 8 is a conceptual diagram for explaining road surface condition determination process according to an embodiment of the present disclosure;

FIG. 9 is a block diagram showing a configuration example of a base control amount calculation unit according to an embodiment of the present disclosure;

FIG. 10 is a diagram for explaining an example of steering reaction force control according to an embodiment of the present disclosure; and

FIG. 11 is a diagram for explaining a modification example of steering reaction force control according to an embodiment of the present disclosure.

### EMBODIMENTS

Embodiments of the present disclosure will be described with reference to the accompanying drawings.

### 1. Overview of Remote Operation System

A remote operation (remote driving) of a moving body is considered. In particular, a remote operation of a moving body traveling on ground is considered. Examples of the moving body include a vehicle, a robot, and the like. The vehicle may be an autonomous driving vehicle or may be a vehicle driven by a driver. Examples of the robot include a logistics robot, a work robot, and the like.

As an example, in the following description, a case where the moving body being the target of the remote operation is a vehicle will be considered. When generalizing, “vehicle” in the following description shall be deemed to be replaced with “moving body.”

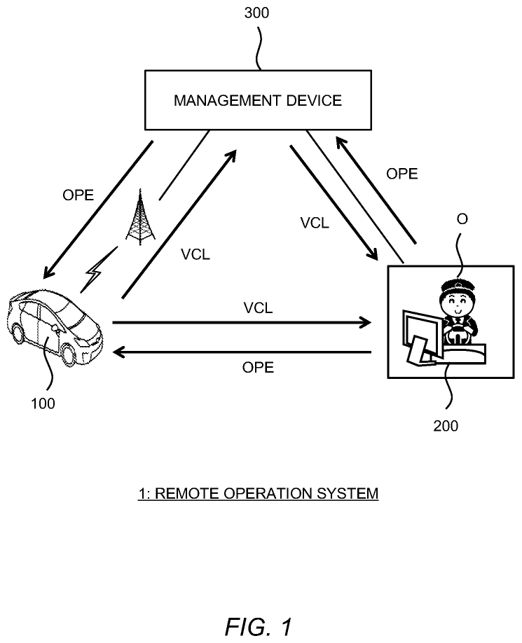

FIG. 1 is a schematic diagram showing a configuration example of a remote operation system 1 according to the present embodiment. The remote operation system 1 includes a vehicle 100, a remote operator terminal 200, and a management device 300. The vehicle 100 is the target of the remote operation. The remote operator terminal 200 is a terminal device used by a remote operator O when remotely operating the vehicle 100. The remote operator terminal 200 can also be referred to as a remote operation human machine interface (HMI). The management device 300 manages the remote operation system 1. Typically, the management device 300 is a management server on a cloud. The management server may be configured by a plurality of servers that perform distributed processing.

The vehicle 100, the remote operator terminal 200, and the management device 300 are capable of communicating with each other via a communication network. The vehicle 100 and the remote operator terminal 200 can communicate with each other via the management device 300. The vehicle 100 and the remote operator terminal 200 may directly communicate with each other without through the management device 300.

Various sensors including a camera are installed on the vehicle 100. The camera captures an image showing a situation around the vehicle 100. Vehicle information VCL includes information acquired by the various sensors and includes at least the image captured by the camera. The vehicle 100 transmits the vehicle information VCL to the remote operator terminal 200.

The remote operator terminal 200 receives the vehicle information VCL transmitted from the vehicle 100. The remote operator terminal 200 presents the vehicle information VCL to the remote operator O. More specifically, the remote operator terminal 200 includes a display device, and displays the image information and the like on the display device. The remote operator O views the displayed information, recognizes the situation around the vehicle 100, and performs the remote operation of the vehicle 100. Remote operation information OPE is information relating to the remote operation performed by the remote operator O. For example, the remote operation information OPE includes an amount of operation performed by the remote operator O. The remote operator terminal 200 transmits the remote operation information OPE to the vehicle 100.

The vehicle 100 receives the remote operation information OPE transmitted from the remote operator terminal 200. The vehicle 100 performs vehicle travel control in accordance with the received remote operation information OPE. In this manner, the remote operation of the vehicle 100 is realized.

### 2. Example of Vehicle

### 2-1. Configuration Example

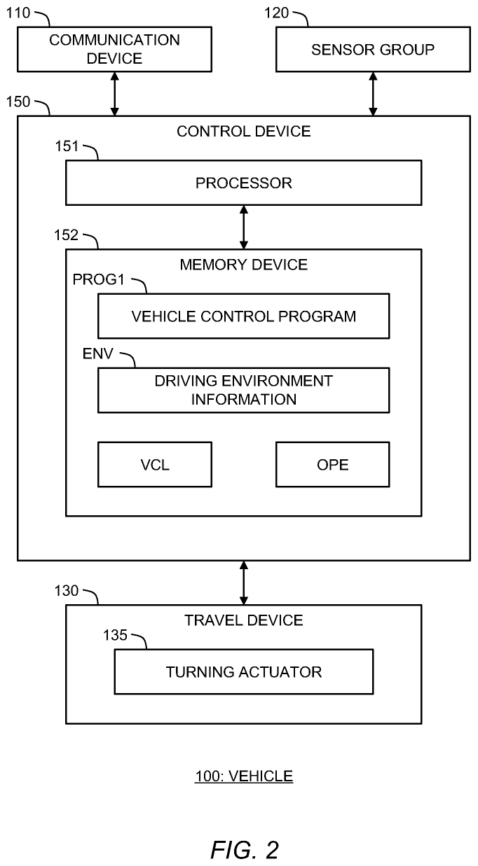

FIG. 2 is a block diagram showing a configuration example of the vehicle 100 according to the present embodiment. The vehicle 100 includes a communication device 110, a sensor group 120, a travel device 130, and a control device 150.

The communication device 110 communicates with the outside of the vehicle 100. For example, the communication device 110 communicates with the remote operator terminal 200 and the management device 300.

The sensor group 120 detects a situation around the vehicle 100, a state of the vehicle 100, and the like. A specific example of the sensor group 120 will be described later.

The travel device 130 includes a driving device, a braking device, and a turning device. The driving device is a power source that generates a driving force. Examples of the driving device include an engine, an electric motor, an in-wheel motor, and the like. The braking device generates a braking force.

The turning device turns (i.e., changing a direction of) a wheel of the vehicle 100. More specifically, the turning device includes a turning actuator 135 for turning (i.e., changing a direction of) the wheel. For example, the turning actuator 135 is a turning motor. A rotor of the turning motor is connected to a turning bar through a speed reducer. The turning bar is coupled with the wheel. When the turning motor rotates, its rotational motion is converted into a linear motion of the turning bar, and thereby the wheel turns (i.e. changes its direction). The turning device is also called an electric power steering (EPS) device.

The control device (controller) 150 is a computer that controls the vehicle 100. The control device 150 includes one or more processors 151 (hereinafter simply referred to as a processor 151) and one or more memory devices 152 (hereinafter simply referred to as a memory device 152). The processor 151 executes a variety of processing. For example, the processor 151 includes a central processing unit (CPU). The memory device 152 stores a variety of information necessary for the processing by the processor 151. Examples of the memory device 152 include a volatile memory, a non-volatile memory, a hard disk drive (HDD), a solid state drive (SSD), and the like. The control device 150 may include one or more electronic control units (ECUs).

A vehicle control program PROG1 is a computer program executed by the processor 151. The functions of the control device 150 are implemented by the processor 151 executing the vehicle control program PROG1. The vehicle control program PROG1 is stored in the memory device 152. The vehicle control program PROG1 may be recorded on a non-transitory computer-readable recording medium.

### 2-2. Driving Environment Information

The control device 150 uses the sensor group 120 to acquire driving environment information ENV indicating a driving environment for the vehicle 100. The driving environment information ENV is stored in the memory device 152.

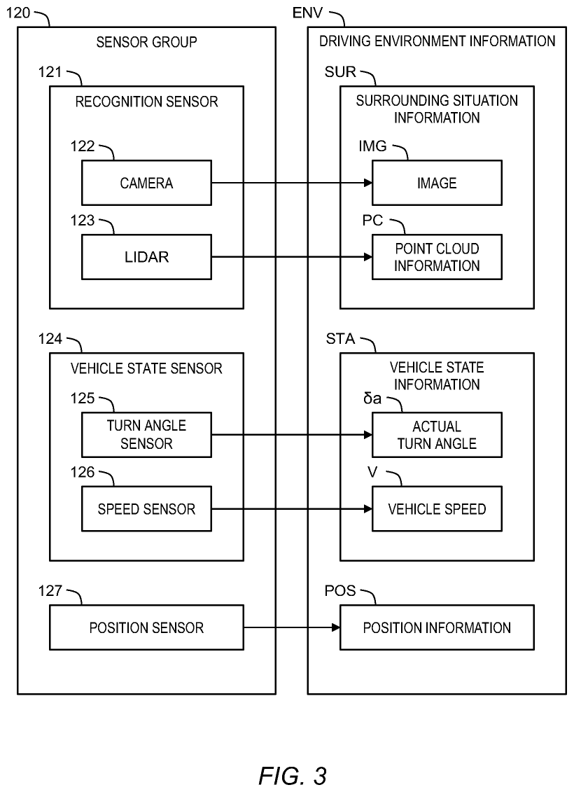

FIG. 3 is a block diagram showing an example of the sensor group 120 and the driving environment information ENV. The sensor group 120 includes a recognition sensor 121, a vehicle state sensor 124, a position sensor 127, and the like. The driving environment information ENV includes surrounding situation information SUR, vehicle state information STA, position information POS, and the like.

The recognition sensor 121 recognizes (detects) a situation around the vehicle 100. For example, the recognition sensor 121 includes a camera 122 that captures an image IMG showing a situation around the vehicle 100. The recognition sensor 121 may include a laser imaging detection and ranging (LIDAR) 123. The recognition sensor 121 may include a radar.

The surrounding situation information SUR is information indicating a result of recognition by the recognition sensor 121, that is, information indicating the situation around the vehicle 100. For example, the surrounding situation information SUR includes the image IMG captured by the camera 122. The surrounding situation information SUR may include point cloud information PC acquired by the LIDAR 123.

The surrounding situation information SUR may include object information regarding an object around the vehicle 100. Examples of the object around the vehicle 100 include a pedestrian, another vehicle (e.g., a preceding vehicle, a parked vehicle, etc.), a white line, a traffic signal, a sign, a roadside structure, and the like. The object information indicates a relative position and a relative velocity of the object with respect to the vehicle 100. For example, analyzing the image IMG captured by the camera 122 makes it possible to identify an object and calculate a relative position of the object. It is also possible to identify an object and acquire a relative position and a relative speed of the object based on the point cloud information PC acquired by the LIDAR 123.

The vehicle state sensor 124 detects a state of the vehicle 100. The vehicle state information STA indicates the state of the vehicle 100 detected by the vehicle state sensor 124.

The vehicle state sensor 124 includes a turn angle sensor 125. The turn angle sensor 125 detects an actual turn angle δa of the wheel of the vehicle 100. For example, the turn angle sensor 125 includes a rotation angle sensor that detects an angle of rotation of the turning actuator 135 (turning motor). The angle of rotation of the turning motor corresponds to the actual turn angle δa. As another example, a pinion angle may be used as the actual turn angle δa. The vehicle state sensor 124 may include a current sensor that detects a turning current that drives the turning actuator 135. The turning current is also related to the actual turn angle δa.

Moreover, the vehicle state sensor 124 includes a speed sensor 126. The speed sensor 126 detects a vehicle speed V of the vehicle 100. In addition, the vehicle state sensor 124 may include a yaw rate sensor, an acceleration sensor, and the like.

The position sensor 127 detects a position and an orientation of the vehicle 100. For example, the position sensor 127 includes a global navigation satellite system (GNSS). The position information POS indicates the position and the orientation of the vehicle 100 acquired by the position sensor 127. Highly accurate position information POS may be acquired by self-position estimation processing (localization) using map information and the surrounding situation information SUR (the object information).

### 2-3. Vehicle Travel Control

The control device 150 executes vehicle travel control that controls travel of the vehicle 100. The vehicle travel control includes turning control, acceleration control, and deceleration control. The control device 150 executes the vehicle travel control by controlling the travel device 130. More specifically, the control device 150 executes the turning control by controlling the turning device. The control device 150 executes the acceleration control by controlling the driving device. Further, the control device 150 executes the deceleration control by controlling the braking device.

The control device 150 may execute autonomous driving control based on the driving environment information ENV. More specifically, the control device 150 generates a travel plan of the vehicle 100 based on the driving environment information ENV. Examples of the travel plan include keeping a current travel lane, making a lane change, making a right or left turn, avoiding an obstacle, and the like. Further, the control device 150 generates, based on the driving environment information ENV, a target trajectory required for the vehicle 100 to travel in accordance with the travel plan. The target trajectory includes a target position and a target speed. Then, the control device 150 executes the vehicle travel control such that the vehicle 100 follows the target trajectory.

### 2-4. Processing Related to Remote Operation

When the remote operation of the vehicle 100 is performed, the control device 150 communicates with the remote operator terminal 200 via the communication device 110.

The control device 150 transmits the vehicle information VCL to the remote operator terminal 200. The vehicle information VCL is information necessary for the remote operation by the remote operator O, and includes at least a part of the driving environment information ENV described above. For example, the vehicle information VCL includes the image IMG captured by the camera 122. The vehicle information VCL may include the surrounding situation information SUR such as the point cloud information PC and the object information. The vehicle information VCL may include the vehicle state information STA. The vehicle information VCL may include the position information POS.

In addition, the control device 150 receives the remote operation information OPE from the remote operator terminal 200. The remote operation information OPE is information regarding the remote operation performed by the remote operator O. For example, the remote operation information OPE includes an amount of operation performed by the remote operator O. The control device 150 performs the vehicle travel control in accordance with the received remote operation information OPE.

### 3. Example of Remote Operator Terminal

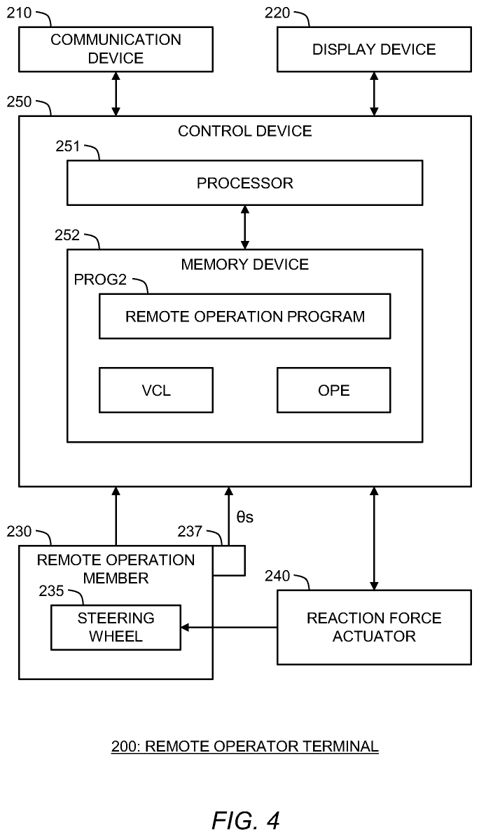

FIG. 4 is a block diagram showing a configuration example of the remote operator terminal 200 according to the present embodiment. The remote operator terminal 200 includes a communication device 210, a display device 220, a remote operation member 230, a reaction force actuator 240, and a control device 250.

The communication device 210 communicates with the vehicle 100 and the management device 300.

The display device 220 presents a variety of information to the remote operator O by displaying the variety of information.

The remote operation member 230 is a member operated by the remote operator O when remotely operating the vehicle 100. The remote operation member 230 includes a steering wheel 235, an accelerator pedal, a brake pedal, a direction indicator, and the like.

An operation amount sensor 237 detects an amount of operation of the remote operation member 230. For example, the operation amount sensor 237 includes a steering angle sensor that detects a steering wheel angle θs that is a steering angle of the steering wheel 235. The operation amount sensor 237 may include a steering torque sensor that detects a steering torque. Moreover, the operation amount sensor 237 includes stroke sensors that detects strokes of the accelerator pedal and the brake pedal.

The reaction force actuator 240 applies a steering reaction force to the steering wheel 235. For example, the reaction force actuator 240 is a reaction force motor. A rotor of the reaction force motor is connected to the steering wheel 235 through a speed reducer. Rotation of the reaction force motor makes it possible to apply the steering reaction force to the steering wheel 235. An operation of the reaction force actuator 240 is controlled by the control device 250.

The control device 250 (controller) controls the remote operator terminal 200. The control device 250 includes one or more processors 251 (hereinafter simply referred to as a processor 251) and one or more memory devices 252 (hereinafter simply referred to as a memory device 252). The processor 251 executes a variety of processing. For example, the processor 251 includes a CPU. The memory device 252 stores a variety of information necessary for the processing by the processor 251. Examples of the memory device 252 include a volatile memory, a non-volatile memory, an HDD, an SSD, and the like.

A remote operation program PROG2 is a computer program executed by the processor 251. The functions of the control device 250 are implemented by the processor 251 executing the remote operation program PROG2. The remote operation program PROG2 is stored in the memory device 252. The remote operation program PROG2 may be recorded on a non-transitory computer-readable recording medium. The remote operation program PROG2 may be provided via a network.

The control device 250 communicates with the vehicle 100 via the communication device 210. The control device 250 receives the vehicle information VCL transmitted from the vehicle 100. The control device 250 presents the vehicle information VCL to the remote operator O by displaying the vehicle information VCL including the image IMG on the display device 220. The remote operator O is able to recognize the state of the vehicle 100 and the situation around the vehicle 100 based on the vehicle information VCL displayed on the display device.

The remote operator O operates the remote operation member 230. The amount of operation of the remote operation member 230 is detected by the operation amount sensor 237. The control device 250 generates the remote operation information OPE reflecting the amount of operation of the remote operation member 230. For example, the remote operation information OPE may include the steering wheel angle θs of the steering wheel 235. The steering wheel angle θs corresponds to the amount of operation of the steering wheel 235 performed by the remote operator O. The remote operation information OPE may include the steering torque. The remote operation information OPE may include the stroke amount of each of the accelerator pedal and the brake pedal. The control device 250 transmits the remote operation information OPE to the vehicle 100 via the communication device 210.

Furthermore, the control device 250 controls the reaction force actuator 240 to apply the steering reaction force to the steering wheel 235. The remote operator O operating the steering wheel 235 feels the steering reaction force applied to the steering wheel 235.

### 4. Steering Reaction Force Control

Hereinafter, the steering reaction force control by the remote operation system 1 according to the present embodiment will be described in more detail. It can be said that the remote operation system 1 supports the remote operation performed by the remote operator O through the steering reaction force control.

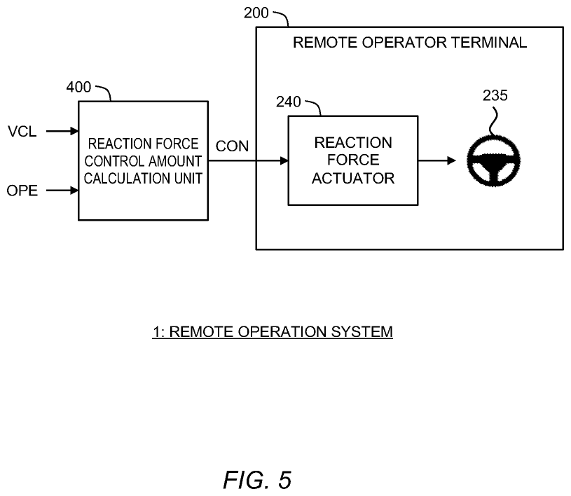

FIG. 5 is a block diagram for explaining an overview of the steering reaction force control according to the present embodiment. The remote operation system 1 includes a “reaction force control amount calculation unit 400.” The reaction force control amount calculation unit 400 calculates a “reaction force control amount CON” for controlling the reaction force actuator 240. Examples of the reaction force control amount CON include a target torque, a target drive current, and the like of the reaction force actuator 240. The reaction force actuator 240 is controlled in accordance with the reaction force control amount CON and applies the steering reaction force according to the reaction force control amount CON to the steering wheel 235.

The reaction force control amount calculation unit 400 can be realized by any of the components of the remote operation system 1. The reason is that the vehicle 100, the remote operator terminal 200, and the management device 300 can communicate with each other and communicate information necessary for calculating the reaction force control amount CON.

For example, the reaction force control amount calculation unit 400 is included in the remote operator terminal 200.

As another example, the reaction force control amount calculation unit 400 may be included in the vehicle 100. In that case, the remote operator terminal 200 receives via communication the reaction force control amount CON calculated by the reaction force control amount calculation unit 400 on the side of the vehicle 100.

As still another example, the function of the reaction force control amount calculation unit 400 may be distributed to the vehicle 100 and the remote operator terminal 200. That is, the reaction force control amount calculation unit 400 may be realized by a cooperation of the vehicle 100 and the remote operator terminal 200.

As still another example, at least a part of the reaction force control amount calculation unit 400 may be included in the management device 300.

When generalized, the reaction force control amount calculation unit 400 is realized by one or more processors and one or more memory device included in the remote operation system 1.

### 4-1. Comparative Example

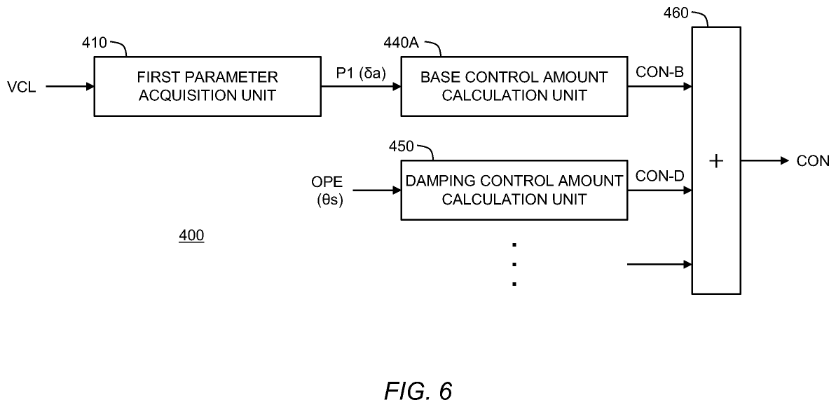

FIG. 6 is a block diagram showing a comparative example of the reaction force control amount calculation unit 400. The reaction force control amount calculation unit 400 includes a first parameter acquisition unit 410, a base control amount calculation unit 440A, a damping control amount calculation unit 450, and an adder unit 460.

The first parameter acquisition unit 410 acquires a “first parameter P1” corresponding to the actual turn angle δa of the vehicle 100. For example, the first parameter P1 is the actual turn angle δa of the vehicle 100. As another example, the first parameter P1 may be a turning current for driving the turning actuator 135 of the vehicle 100. The first parameter acquisition unit 410 can acquire the first parameter P1 from the vehicle information VCL.

The base control amount calculation unit 440A calculates a base control amount CON-B for generating a base steering reaction force component. For example, the base steering reaction force component includes a spring component corresponding to a self-aligning torque applied to the wheel. The base control amount calculation unit 440A calculates the base control amount CON-B based on the first parameter P1 related to the actual turn angle δa of the vehicle 100. For example, the base control amount CON-B increases as the actual turn angle δa increases. In consideration of the vehicle speed V, the base control amount calculation unit 440A may calculate the base control amount CON-B based on the first parameter P1 and the vehicle speed V.

The damping control amount calculation unit 450 acquires the steering wheel angle θs included in the remote operation information OPE. Then, the damping control amount calculation unit 450 calculates a damping control amount CON-D for generating a damping component according to a steering speed (dθs/dt) of the steering wheel 235.

A steering reaction force component other than the spring component and the damping component may be generated.

The adder unit 460 calculates a final reaction force control amount CON by adding the base control amount CON-B, the damping control amount CON-D, and the like.

### 4-2. Problems

The steering reaction force control according to the comparative example described above makes it possible for the remote operator O to obtain a steering feeling according to actual travel of the vehicle 100. However, when the vehicle 100 travels on an uneven road surface, an operation of the steering wheel 235 may be affected by the unevenness of the road surface, which may make it difficult for the remote operator O to stably perform the steering operation. When the steering operation performed by the remote operator O becomes unstable, the travel of the vehicle 100 being the target of the remote operation may also become unstable.

In particular, in the case of the remote operation, there is a communication delay between the vehicle 100 and the remote operator terminal 200. Due to the communication delay, the remote operation of the vehicle 100 performed by the remote operator O may become awkward. In such a circumstance, it is desirable to avoid a situation in which the remote operation performed by the remote operator O is further disturbed by “disturbance” such as the road surface unevenness.

On the other hand, when the vehicle 100 travels on an off-road at a very low speed, such a need that the remote operator O desires to feel a sense of the off-road is conceivable. Therefore, such a technique that is capable of flexibly adjusting the steering reaction force depending on a situation is desirable.

### 4-3. Steering Reaction Force Control in Consideration of Road Surface Condition and Vehicle Speed

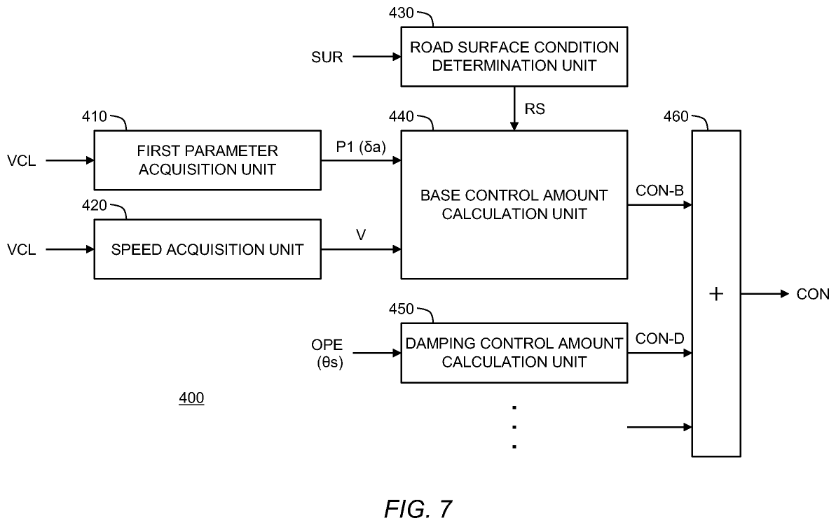

FIG. 7 is a block diagram showing a configuration example of the reaction force control amount calculation unit 400 according to the present embodiment. The reaction force control amount calculation unit 400 includes a first parameter acquisition unit 410, a speed acquisition unit 420, a road surface condition determination unit 430, a base control amount calculation unit 440, a damping control amount calculation unit 450, and an adder unit 460. The damping control amount calculation unit 450 and the adder unit 460 are the same as those in the comparative example described above.

The first parameter acquisition unit 410 is the same as that of the comparative example described above. That is, the first parameter acquisition unit 410 acquires the “first parameter P1” corresponding to the actual turn angle δa of the vehicle 100. For example, the first parameter P1 is the actual turn angle δa of the vehicle 100. As another example, the first parameter P1 may be a turning current for driving the turning actuator 135 of the vehicle 100. The first parameter acquisition unit 410 can acquire the first parameter P1 from the vehicle information VCL.

The speed acquisition unit 420 acquires the vehicle speed V of the vehicle 100. The vehicle speed V is acquired from the vehicle information VCL.

The road surface condition determination unit 430 determines whether or not a road surface condition in front of the vehicle 100 satisfies a certain condition. In the present embodiment, a “road surface roughness” is considered as the road surface condition. It can be said that the road surface roughness R is a degree of unevenness of the road surface. As the road surface roughness R is higher, the degree of unevenness of the road surface is higher. The road surface condition determination unit 430 determines whether or not the road surface roughness R in front of the vehicle 100 is equal to or greater than a threshold value Rth. That is, the road surface condition determination unit 430 determines whether or not the road surface in front of the vehicle 100 is an uneven road surface.

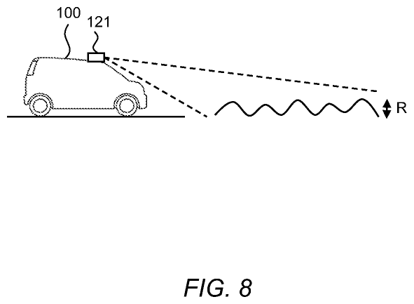

FIG. 8 is a conceptual diagram for explaining a road surface condition determination process. As described above, the recognition sensor 121 that recognizes the situation around the vehicle 100 is mounted on the vehicle 100. The surrounding situation information SUR indicates the result of recognition by the recognition sensor 121. Based on the surrounding situation information SUR, the road surface condition determination unit 430 determines whether or not the road surface roughness R in a predetermined range in front of the vehicle 100 is equal to or greater than the threshold value Rth.

For example, the surrounding situation information SUR includes the image IMG captured by the camera 122. The road surface condition determination unit 430 analyzes the image IMG to determine whether or not the road surface roughness R in the predetermined range in front of the vehicle 100 is equal to or greater than the threshold value Rth. For example, a large amount of learning data indicating combinations of the images IMG and the road surface roughness R in various scenes is prepared, and image recognition AI (Artificial Intelligence) is prepared in advance by machine learning using the learning data. The image recognition AI inputs the image IMG and outputs the road surface roughness R of the road surface included in the image IMG. Alternatively, the image recognition AI may input the image IMG and output information indicating whether or not the road surface roughness R is equal to or greater than the threshold value Rth. The road surface condition determination unit 430 can estimate the road surface roughness R in front of the vehicle 100 by utilizing the image recognition AI. Alternatively, the road surface condition determination unit 430 can determine whether or not the road surface roughness R in front of the vehicle 100 is equal to or greater than the threshold value Rth by using the image recognition AI.

As another example, the surrounding situation information SUR includes the point cloud information PC acquired by the LIDAR 123. The point cloud information PC includes a relative position (a direction and a relative distance) of each measurement point with respect to the vehicle 100. Therefore, a height distribution of the point cloud can be acquired from the point cloud information PC. The road surface condition determination unit 430 extracts a road surface point cloud representing the road surface in the predetermined range in front of the vehicle 100 from the point cloud indicated by the point cloud information PC. Subsequently, the road surface condition determination unit 430 acquires a height distribution of the road surface point cloud based on the point cloud information PC of the road surface point cloud. Then, the road surface condition determination unit 430 calculates the road surface roughness R in front of the vehicle 100 based on variance of the height distribution of the road surface point cloud. As the variance of the height distribution of the road surface point cloud increases, the road surface roughness R increases. The road surface condition determination unit 430 determines whether or not the road surface roughness R thus calculated is equal to or greater than the threshold value Rth.

The road surface condition determination unit 430 outputs road surface condition information RS. The road surface condition information RS includes the road surface roughness R in front of the vehicle 100. The road surface condition information RS may include a road surface condition flag indicating whether or not the road surface roughness R in front of the vehicle 100 is equal to or greater than the threshold value Rth.

The base control amount calculation unit 440 calculates a base control amount CON-B (“first reaction force control amount”) for generating a base steering reaction force component. For example, the base steering reaction force component includes a spring component corresponding to a self-aligning torque applied to the wheel. The base control amount calculation unit 440 receives the first parameter P1, the vehicle speed V, and the road surface condition information RS. The base control amount calculation unit 440 calculates the base control amount CON-B based on the first parameter P1, and further appropriately adjusts the base control amount CON-B according to the road surface condition information RS and the vehicle speed V. It is also possible to replace “adjusting” with “correcting.”

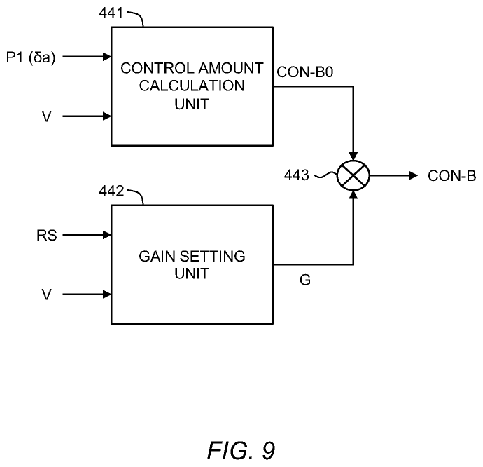

FIG. 9 is a block diagram showing a configuration example of the base control amount calculation unit 440. The base control amount calculation unit 440 includes a control amount calculation unit 441, a gain setting unit 442, and a multiplication unit 443.

The control amount calculation unit 441 calculates the base control amount CON-B based on the first parameter P1 corresponding to the actual turn angle δa of the vehicle 100. For example, as the actual turn angle δa increases, the base control amount CON-B increases. In consideration of the vehicle speed V, the control amount calculation unit 441 may calculate the base control amount CON-B based on the first parameter P1 and the vehicle speed V. The base control amount CON-B output from the control amount calculation unit 441, that is, the base control amount CON-B before adjustment is hereinafter referred to as a “base control amount CON-B0” for the sake of convenience.

The gain setting unit 442 receives the road surface condition information RS and the information of the vehicle speed V. The gain setting unit 442 sets a gain G according to the road surface roughness R and the vehicle speed V. The multiplication unit 443 calculates the base control amount CON-B by multiplying the base control amount CON-B0 before adjustment by the gain G. That is to say, the base control amount CON-B is adjusted by the gain G. The gain G being higher than 1 means that the base control amount CON-B is adjusted such that the steering reaction force increases. The gain G being lower than 1 means that the base control amount CON-B is adjusted such that the steering reaction force decreases. When the gain G=1, the base control amount CON-B0 before adjustment and the base control amount CON-B after adjustment are the same, and an adjustment width (correction width) is 0. The case where the gain G=1 is also included in the concept of “adjustment (correction).”

As described above, the base control amount calculation unit 440 adjusts the base control amount CON-B, that is, the steering reaction force according to the road surface roughness R in front of the vehicle 100 and the vehicle speed V. That is, the base control amount calculation unit 440 adjusts the base control amount CON-B, that is, the steering reaction force depending on a situation. Hereinafter, examples of the adjustment of the steering reaction force will be described.

### 4-4. Examples of Adjustment

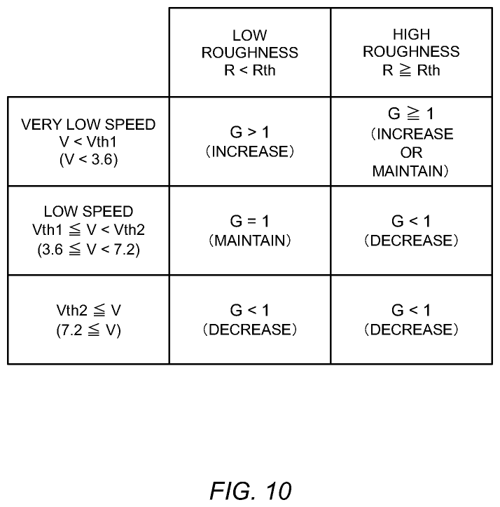

FIG. 10 shows examples of the adjustment of the steering reaction force according to the road surface roughness R and the vehicle speed V.

A first speed threshold value Vth1 is a threshold value for distinguishing between very low speed traveling and low speed traveling. For example, the first speed threshold value Vth1 is 3.6 km/h. When the vehicle speed V is lower than the first speed threshold value Vth1 (V<Vth1), it is determined that the vehicle 100 is traveling at a very low speed. A second speed threshold value Vth2 is a threshold value for distinguishing between the low speed traveling and higher speed traveling, and is higher than the first speed threshold value Vth1. For example, the second speed threshold value Vth2 is 7.2 km/h. When the vehicle speed V is lower than the second speed threshold value Vth2 (V<Vth2), it is determined that the vehicle 100 is traveling at a low speed.

4-4-1. Case where R≥Rth

First, a case where the road surface roughness R is equal to or greater than a threshold value Rth, that is, a case where the road surface unevenness is large will be considered.

When the road surface roughness R is equal to or greater than the threshold value Rth and the vehicle speed V is equal to or higher than the first speed threshold value Vth1 (R≥Rth, V≥Vth1), the gain G is set to be lower than 1 (G<1). That is, the base control amount CON-B is adjusted so as to decrease the steering reaction force applied to the steering wheel 235. Therefore, in a situation where the vehicle 100 travels on an uneven road surface, it is possible to suppress the road surface unevenness (disturbance) from being transmitted to the side of the remote operator O. As a result, its influence on the steering wheel 235 is suppressed, and thus stability of the remote operation (the steering operation) performed by the remote operator O is ensured. Since the stability of the remote operation performed by the remote operator O is ensured, travel stability of the vehicle 100 is also ensured.

In particular, in the case of the remote operation, there is a communication delay between the vehicle 100 and the remote operator terminal 200. Due to the communication delay, the remote operation of the vehicle 100 performed by the remote operator O may become awkward. In such a circumstance, it is possible to avoid a situation in which the remote operation performed by the remote operator O is further disturbed by “disturbance” such as the road surface unevenness.

Moreover, in the present embodiment, not the road surface roughness R immediately below the vehicle 100 but the road surface roughness R in front of the vehicle 100 is taken into consideration. Accordingly, it is possible to more certainly prevent the influence of the road surface unevenness (disturbance) from being transmitted to the side of the remote operator O.

On the other hand, when the vehicle 100 travels on an off-road at a very low speed, such a need that the remote operator O desires to feel a sense of the off-road is conceivable. In view of the above, when the road surface roughness R is equal to or greater than the threshold value Rth and the vehicle speed V is lower than the first speed threshold value Vth1 (R≥Rth, V<Vth1), the gain G is set to 1 or higher (G≥1). For example, the gain G is set to 1 (G=1). That is, the base control amount CON-B is adjusted so as not to decrease the steering reaction force applied to the steering wheel 235. Thus, the remote operator O is able to effectively feel the sense of the uneven road surface such as the off-road. It should be noted that in the case of very low speed traveling, it is possible to immediately stop the vehicle 100 even if the travel stability of the vehicle 100 is lowered.

4-4-2. Case where R<Rth

Next, a case where the road surface roughness R is less than the threshold value Rth, that is, a case where the road surface unevenness is small will be considered.

When the road surface roughness R is less than the threshold value Rth and the vehicle speed V is equal to or higher than the first speed threshold value Vth1 and lower than the second speed threshold value Vth2 (R<Rth, Vth1≤V<Vth2), the gain G is set to 1 (G=1). That is, the adjustment width of the base control amount CON-B is set to 0. As a result, the remote operator O is able to obtain a steering feeling according to actual travel of the vehicle 100.

When the road surface roughness R is less than the threshold value Rth and the vehicle speed V is equal to or higher than the second speed threshold value Vth2 (R<Rth, V≥Vth2), the gain G is set to be lower than 1 (G<1). That is, the base control amount CON-B is adjusted so as to decrease the steering reaction force applied to the steering wheel 235. For example, crosswind during high-speed traveling can also be “disturbance” that affects the steering operation. Setting the gain G to be lower than 1 makes it possible to suppress such the disturbance from being transmitted to the side of the remote operator O.

When the road surface roughness R is less than the threshold value Rth and the vehicle speed V is lower than the first speed threshold value Vth1 (R<Rth, V<Vth1), the gain G is set to be higher than 1 (G>1). That is, the base control amount CON-B is adjusted so as to increase the steering reaction force applied to the steering wheel 235. For example, when a wheel comes into contact with a low curb during very low speed traveling, the information is amplified and transmitted to the remote operator O. This makes it possible for the remote operator O to clearly recognize the presence of the curb even in the case of the low curb.

### 4-5. Effects

As described above, according to the present embodiment, the steering reaction force is adjusted according to the road surface condition (the road surface roughness R) in front of the vehicle 100 and the vehicle speed V. That is, the steering reaction force is flexibly adjusted depending on a situation. Therefore, remote operability of the vehicle 100 by the remote operator O is improved.

### 5. Modification Example

In the modification example, a “friction coefficient μ of a road surface” is considered as the road surface condition. The road surface condition determination unit 430 estimates the friction coefficient μ of the road surface in front of the vehicle 100. Then, the road surface condition determination unit 430 determines whether or not the friction coefficient μ of the road surface in front of the vehicle 100 is lower than a threshold value μth. In other words, the road surface condition determination unit 430 determines whether the road surface in front of the vehicle 100 is a low-μ road or a high-μ road.

For example, the surrounding situation information SUR includes the image IMG captured by the camera 122. The road surface condition determination unit 430 analyzes the image IMG to determine whether the road surface in a predetermined range in front of the vehicle 100 is a low-μ road or a high-μ road. For example, a large amount of learning data indicating combinations of the images IMG and the friction coefficients μ in various scenes is prepared, and image recognition AI is prepared in advance by machine learning using the learning data. The image recognition AI inputs the image IMG and outputs the friction coefficient μ of the road surface included in the image IMG. Alternatively, the image recognition AI may input the image IMG and output information indicating whether or not the friction coefficient μ is lower than the threshold value μth. The road surface condition determination unit 430 can estimate the friction coefficient μ of the road surface in front of the vehicle 100 by utilizing the image recognition AI. Alternatively, the road surface condition determination unit 430 can determine whether or not the friction coefficient μ of the road surface in front of the vehicle 100 is equal to or higher than the threshold value μth by using the image recognition AI.

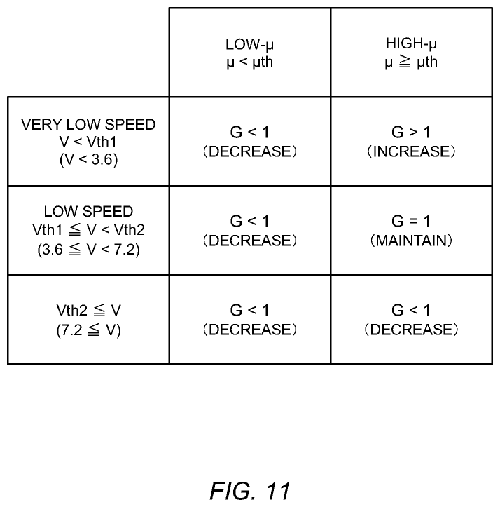

FIG. 11 shows examples of the adjustment of the steering reaction force according to the friction coefficient μ and the vehicle speed V.

First, the case of the low-μ road where the friction coefficient μ is lower than the threshold value μth will be considered. When the friction coefficient μ is lower than the threshold value μth (μ<μth), the gain G is set to lower than 1 (G<1). In other words, the base control amount CON-B is adjusted so as to decrease the steering reaction force applied to the steering wheel 235. As a result, a “slip-off feeling” of the steering wheel 235 on the low-μ road is reproduced.

Next, the case of the high-μ road where the friction coefficient μ is equal to or higher than the threshold value μth will be considered.

When the friction coefficient μ is equal to or higher than the threshold value μth and the vehicle speed V is equal to or higher than the first speed threshold value Vth1 and lower than the second speed threshold value Vth2 (μ≥μth, Vth1≤V<Vth2), the gain G is set to 1 (G=1). That is, the adjustment width of the base control amount CON-B is set to 0. As a result, the remote operator O is able to obtain a steering feeling according to actual travel of the vehicle 100.

When the friction coefficient μ is equal to or higher than the threshold value μth and the vehicle speed V is equal to or higher than the second speed threshold value Vth2 (μ≥μth, V≥Vth2), the gain G is set to be lower than 1 (G<1). That is, the base control amount CON-B is adjusted so as to decrease the steering reaction force applied to the steering wheel 235. For example, crosswind during high-speed traveling can also be “disturbance” that affects the steering operation. Setting the gain G to be lower than 1 makes it possible to suppress such the disturbance from being transmitted to the side of the remote operator O.

When the friction coefficient μ is equal to or higher than the threshold value μth and the vehicle speed V is lower than the first speed threshold value Vth1 (μ≥μth, V<Vth1), the gain G is set to be higher than 1 (G>1). That is, the base control amount CON-B is adjusted so as to increase the steering reaction force applied to the steering wheel 235. For example, when a wheel comes into contact with a low curb during very low speed traveling, the information is amplified and transmitted to the remote operator O. This makes it possible for the remote operator O to clearly recognize the presence of the curb even in the case of the low curb.

As described above, according to the present embodiment, the steering reaction force is adjusted according to the road surface condition (the friction coefficient μ) in front of the vehicle 100 and the vehicle speed V. That is, the steering reaction force is flexibly adjusted depending on a situation. Therefore, remote operability of the vehicle 100 by the remote operator O is improved.

What is claimed is:

1. A remote operation system for supporting a remote operation of a moving body performed by a remote operator,
the remote operation system comprising one or more processors configured to:
determine a road surface condition in front of the moving body based on a result of recognition by a recognition sensor mounted on the moving body;
calculate a first reaction force control amount based on a first parameter corresponding to an actual turn angle of the moving body;
adjust the first reaction force control amount according to the road surface condition and a speed of the moving body; and
apply a steering reaction force corresponding to the adjusted first reaction force control amount to a steering wheel operated by the remote operator.

2. The remote operation system according to claim 1, wherein
the road surface condition includes a road surface roughness.

3. The remote operation system according to claim 2, wherein
when the road surface roughness is equal to or greater than a threshold value and the speed is equal to or higher than a first speed threshold value, the one or more processors are configured to adjust the first reaction force control amount so as to decrease the steering reaction force.

4. The remote operation system according to claim 2, wherein
when the road surface roughness is equal to or greater than a threshold value and the speed is lower than a first speed threshold value, the one or more processors are configured to adjust the first reaction force control amount so as not to decrease the steering reaction force.

5. The remote operation system according to claim 2, wherein
when the road surface roughness is less than a threshold value and the speed is lower than a first speed threshold value, the one or more processors are configured to adjust the first reaction force control amount so as to increase the steering reaction force.

6. The remote operation system according to claim 2, wherein
when the road surface roughness is less than a threshold value and the speed is equal to or higher than a second speed threshold value higher than a first speed threshold value, the one or more processors are configured to adjust the first reaction force control amount so as to decrease the steering reaction force.

7. The remote operation system according to claim 2, wherein
the recognition sensor includes a camera configured to capture an image showing a situation around the moving body, and
the one or more processors are configured to analyze the image to estimate the road surface roughness in front of the moving body.

8. The remote operation system according to claim 2, wherein
the recognition sensor includes a laser imaging detection and ranging configured to acquire a point cloud around the moving body, and
the one or more processors are configured to calculate the road surface roughness in front of the moving body based on a height distribution of the point cloud of a road surface in front of the moving body.

9. The remote operation system according to claim 1, wherein
the road surface condition includes a friction coefficient of a road surface.

10. The remote operation system according to claim 9, wherein
when the friction coefficient is lower than a threshold value, the one or more processors are configured to adjust the first reaction force control amount so as to decrease the steering reaction force.

11. The remote operation system according to claim 9, wherein
when the friction coefficient is equal to or higher than a threshold value and the speed is lower than a first speed threshold value, the one or more processors are configured to adjust the first reaction force control amount so as to increase the steering reaction force.

12. The remote operation system according to claim 9, wherein
when the friction coefficient is equal to or higher than a threshold value and the speed is equal to or higher than a second speed threshold value higher than a first speed threshold value, the one or more processors are configured to adjust the first reaction force control amount so as to decrease the steering reaction force.

13. A remote operation support method for supporting a remote operation of a moving body performed by a remote operator,
the remote operation support method comprising:
determining a road surface condition in front of the moving body based on a result of recognition by a recognition sensor mounted on the moving body;
calculating a first reaction force control amount based on a first parameter corresponding to an actual turn angle of the moving body;
adjusting the first reaction force control amount according to the road surface condition and a speed of the moving body; and
applying a steering reaction force corresponding to the adjusted first reaction force control amount to a steering wheel operated by the remote operator.
